(19) United States
(12) Patent Application Publication
(10) Pub. No.: US 2005/0182720 A1
(43) Pub. Date: Aug. 18, 2005

(54) ONLINE PAYMENT SYSTEM AND METHOD

(75) Inventors: Rick L. Willard, Las Vegas, NV (US); Omar F. Khandaker, Las Vegas, NV (US)

Correspondence Address: HALLISKY & PHILIPP, 1725 WESTLAKE AVENUE NORTH, SUITE 150, SEATTLE, WA, 98109, US

(73) Assignee: WOW! TECHNOLOGIES, INC., Las Vegas, NV (US)

(21) Appl. No.: 10/905,989

(22) Filed: Jan. 28, 2005

Related U.S. Application Data
(63) Continuation-in-part of application No. 10/374,737, filed on Feb. 24, 2003.

(51) Int. Cl. G06F 17/60

(52) U.S. Cl. 705/40

(57) ABSTRACT

The present invention provides a loadable debit card capable of online payments to merchants for good and/or services.

### CROSS-REFERENCE TO RELATED APPLICATION

This application is a continuation-in-part of U.S. patent application Ser. No. 10/374,737, entitled LOADABLE DEBIT CARD SYSTEM AND METHOD, with the named inventor Rick Willard, filed on Feb. 23, 2003, which is hereby incorporated by reference.

### FIELD

The present invention generally relates to debit network transactions and, more particularly, to network initiated debit card transactions.

### BACKGROUND

Debit cards and gift cards are well known in the art. Such cards are typically linked to a user's bank account or are purchased from a vendor and come in fixed value increments, for example, $10, $20, and $50. A $10 card provides the customer with $10 of purchasing power utilizing an existing debit card system. In the operation of prior art systems, cards are batch activated by the card provider in a limited number of predetermined values. A customer purchases one of these pre activated cards by paying a fee. The cards typically include a predetermined identification code.

Such systems have proved commercially successful and desirable for a number of reasons. Gift cards allow customers to present recipients of gifts with a convenient and easy to use payment mechanism. However, once the card has been used by the recipient, its usefulness is exhausted, and it is generally thrown away.

Additionally, many merchants have little or no incentive to sell cards, and neither do other parties in the supply chain system. Current debit card and gift card technologies do not allow for distributing fees associated with these cards to a wide audience to create incentives to distribute the cards.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a pictorial diagram of a number of interconnected devices that provide a connected point of sale device card loading functionality in accordance with embodiments of the present invention.

FIG. 2 is a block diagram of a card managing server device that provides an exemplary operating environment for an embodiment of the present invention.

FIG. 3 is an exemplary diagram of a point-of-sale device that provides an exemplary operating environment for an embodiment of the present invention.

FIG. 4 is an exemplary diagram of a loadable debit card in accordance with embodiments of the present invention.

FIG. 5 is a diagram illustrating the actions taken by devices in a loadable debit card system for loading value to a loadable debit card in accordance with embodiments of the present invention.

FIG. 6 is a flow diagram illustrating a card loading routine in accordance with embodiments of the present invention.

FIG. 7 is a diagram illustrating the actions taken by devices in a loadable debit card system for activating a loadable debit card in accordance with embodiments of the present invention.

FIG. 8 is a flow diagram illustrating a card activation routine in accordance with embodiments of the present invention.

FIG. 9 is a diagram illustrating the actions taken by devices in a loadable debit card system to settle payment and fees in accordance with embodiments of the present invention.

FIG. 10 is a flow diagram illustrating a settlement routine in accordance with embodiments of the present invention.

FIG. 11 is a diagram illustrating loadable debit card fee distributions in accordance with embodiments of the present invention.

FIG. 12 is a diagram illustrating the actions taken by devices in a loadable debit card system to access an account statement in accordance with embodiments of the present invention.

FIG. 13 is a flow diagram illustrating a card account statement routine in accordance with embodiments of the present invention.

FIG. 14 is a pictorial diagram of a number of interconnected devices that provide a connected consumer device card online payment and transfer functionality in accordance with embodiments of the present invention.

FIG. 15 is a diagram illustrating the actions taken by devices in a loadable debit card system to pay for goods or services in accordance with embodiments of the present invention.

FIG. 16 is a flow diagram illustrating an online card payment routine in accordance with embodiments of the present invention.

FIG. 17 is a diagram illustrating the actions taken by devices in a loadable debit card system for loading value in a merchant debit card in accordance with embodiments of the present invention.

FIG. 18 is a flow diagram illustrating a merchant card loading routine in accordance with embodiments of the present invention.

FIG. 19 is a diagram illustrating the actions taken by devices in a loadable debit card system to transfer value from a loadable debit card to a bank account in accordance with embodiments of the present invention.

FIG. 20 is a flow diagram illustrating a card transfer routine in accordance with embodiments of the present invention.

FIG. 21 is a diagram illustrating the actions taken by devices in a debit card system for transferring value from one bank account to another bank account in accordance with embodiments of the present invention.

FIG. 22 is a flow diagram illustrating an inter-bank transfer routine in accordance with embodiments of the present invention.

### DETAILED DESCRIPTION

Attached are figures illustrating embodiments of the present invention. Those of ordinary skill in the art will appreciate that other embodiments, including additional devices, or combinations of illustrated devices, may be added to or combined in the present invention without changing the spirit or scope of the present invention.

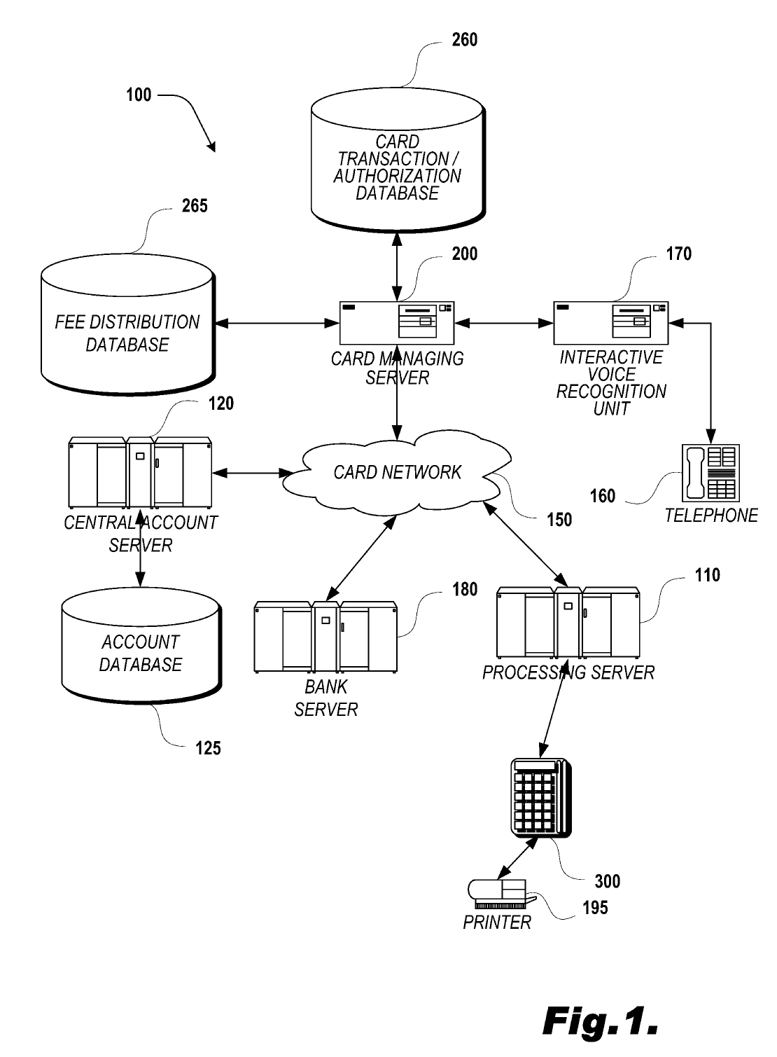

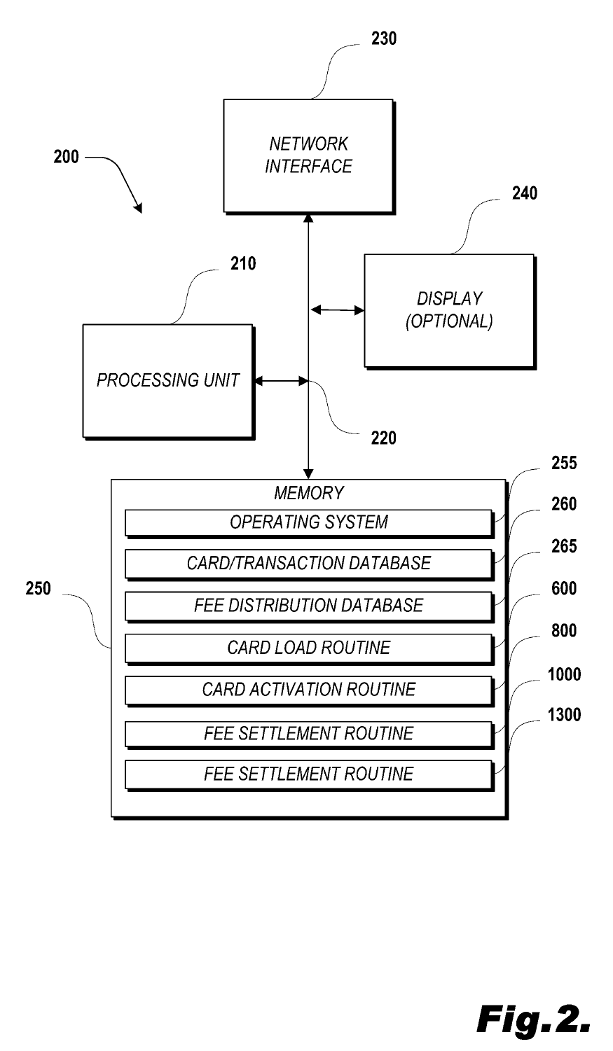

FIG. 1 illustrates an exemplary embodiment of a number of devices used in an exemplary embodiment of the present invention. FIG. 1 illustrates point of sale terminals 300 (optionally having a printer 195) connected to a processing server 110, which controls the interactions of the point of sale terminals 300 and a card network 150, such as a network provided by any of the well known debit/credit card transaction network providers (e.g., Star, Cirrus, Visa, MasterCard, American Express, Diners Club, etc.). Also in communication with the card network 150 is a central account server 120, having an account database 125 for managing individual card accounts. It will be appreciated by one of ordinary skill in the art that there may be a plurality of central account servers for managing account databases 125, or even that the role of the central account server 120 may be performed by another device such as bank server 180. Additionally, connected to the card network 150 is a card managing server 200, illustrated in FIG. 2 and described below. However, illustrated in FIG. 1 the card managing server 200 also includes a card transaction/authorization database 260, which maintains information about individual cards and the transactions associated with them, and a fee distribution database 265 for determining how card fees will be distributed. It will be appreciated by those of ordinary skill in the art and others that the card transaction/authorization database 260 and fee distribution database 265 may comprise a plurality of databases or may be a single database. Additionally, in communication with the card managing server 200 is an interactive voice recognition unit (“IVRU”) 170 connected to a telephone 160 for communication between a user and the card managing server 200. It will be appreciated by one of ordinary skill in the art that the telephone 160 may be connected to the IVRU 170 via any conventional telephone connection such as through a publicly switched telephone network (not shown).

FIG. 2 illustrates several of the key components of the card managing server 200. Those of ordinary skill in the art will appreciate that the card managing server 200 may include many more components than those shown in FIG. 2. However, it is not necessary that all of these generally conventional components be shown in order to disclose an illustrative embodiment for practicing the present invention. As shown in FIG. 2, the card managing server 200 includes a network interface 230 for connecting to the card network 150. Those of ordinary skill in the art will appreciate that the network interface 230 includes the necessary circuitry for such a connection and is constructed for use with the appropriate protocol.

The card managing server 200 also includes a processing unit 210, may include an optional display 240, and a memory 250, all inter collected along with the network interface 230 via a bus 220. The memory 250 generally comprises a random access memory (“RAM”), a read only memory (“ROM”), and a permanent mass storage device, such as a disk drive. The memory 250 stores the program code necessary for a card real-time load routine 600, a card activation routine 800, a fee settlement routine 1000 and a statement retrieval routine 1300, in addition to the card transaction/authorization database 260 and fee distribution database 265. In addition, the memory 250 also stores an operating system 255. It will be appreciated that these software components may be loaded from a computer readable medium into memory 250 of the card managing server 200 using a drive mechanism (not shown) associated with a computer readable medium, such as a floppy disc, tape, DVD/CD-ROM drive or via the network interface 230.

Although an exemplary card managing server 200 has been described that generally conforms to conventional general purpose computing devices, those of ordinary skill in the art will appreciate that a card managing server may be any of a great number of devices capable of communicating with the card network 150 or with the interactive voice recognition unit 170.

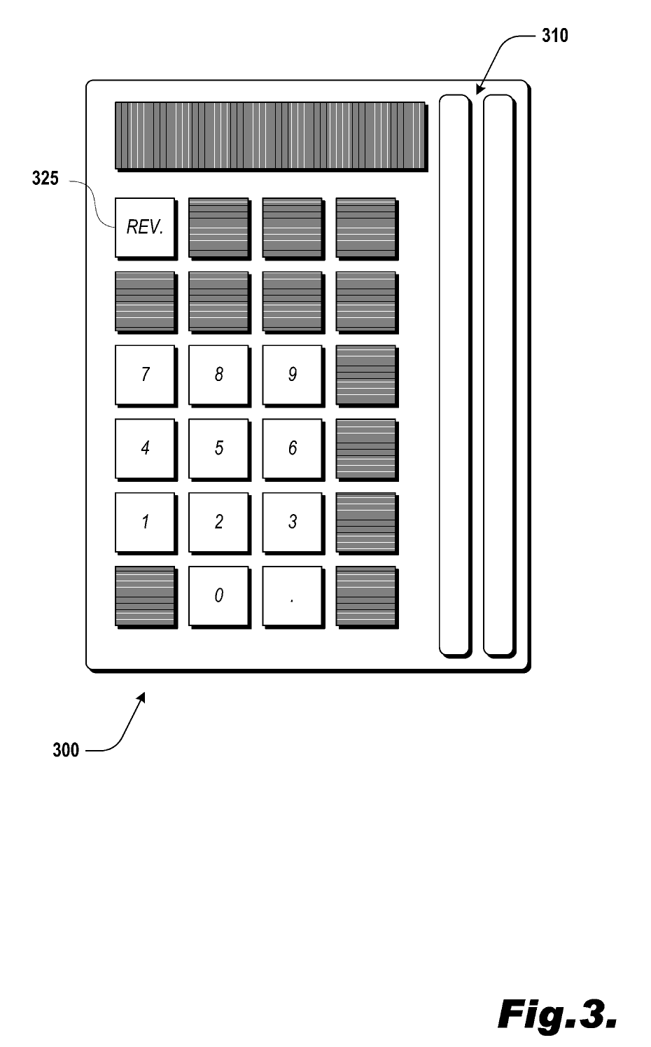

FIG. 3 depicts an exemplary point-of-sale (“POS”) device 300 for use in the present invention. The POS device 300 includes a card reader 310 and a transaction reversal button 325. Although an exemplary POS device 300 has been described and shown in FIG. 3, those of ordinary skill in the art will appreciate that POS devices may take many forms and may include many additional components other than those shown in FIG. 3. For example, the POS device 300 may include a connection to a printer 195 for printing information received at the POS device 300.

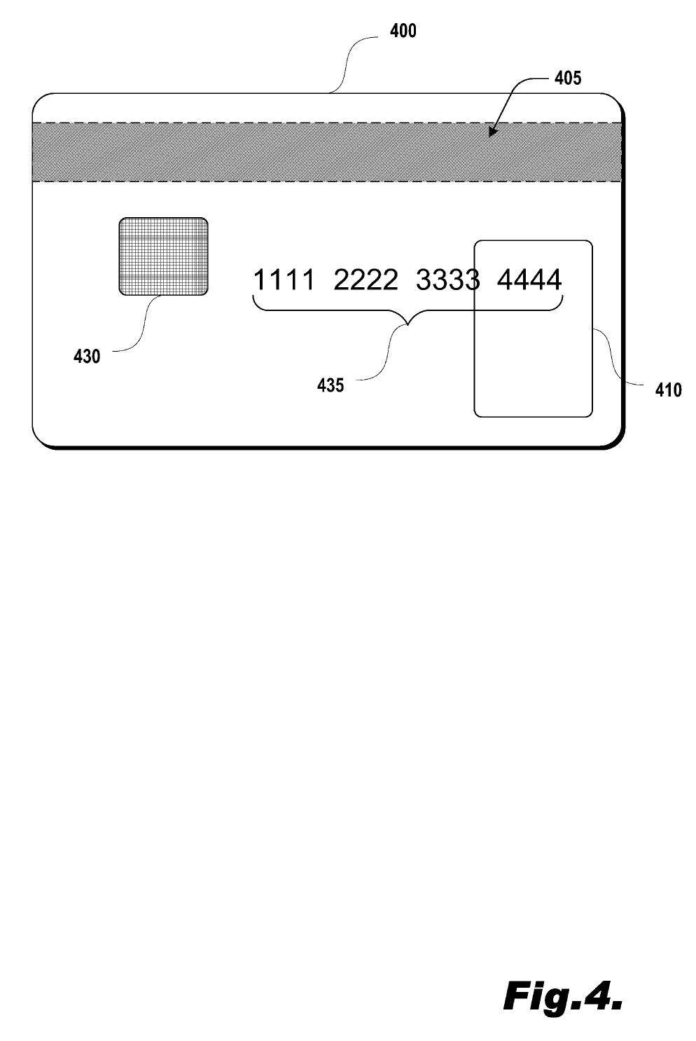

FIG. 4 illustrates an exemplary card 400, such as a loadable debit card in accordance with the present invention. The card 400 may include a magnetic strip 405, a smart card chip interface 430, embossed account numbers 435 and/or fraud prevention components 410 (e.g., decals, photographs, holograms, etc.). It will be appreciated by those of ordinary skill in the art that the card 400 may include any of the magnetic strip 405, smart card chip interface 430, and embossed numbers 435 to be effective as a loadable debit card. It will further be appreciated that additional means of storing information or providing information on the card may also be used. In one exemplary embodiment, a security code may be printed or embossed on the card 400 as well.

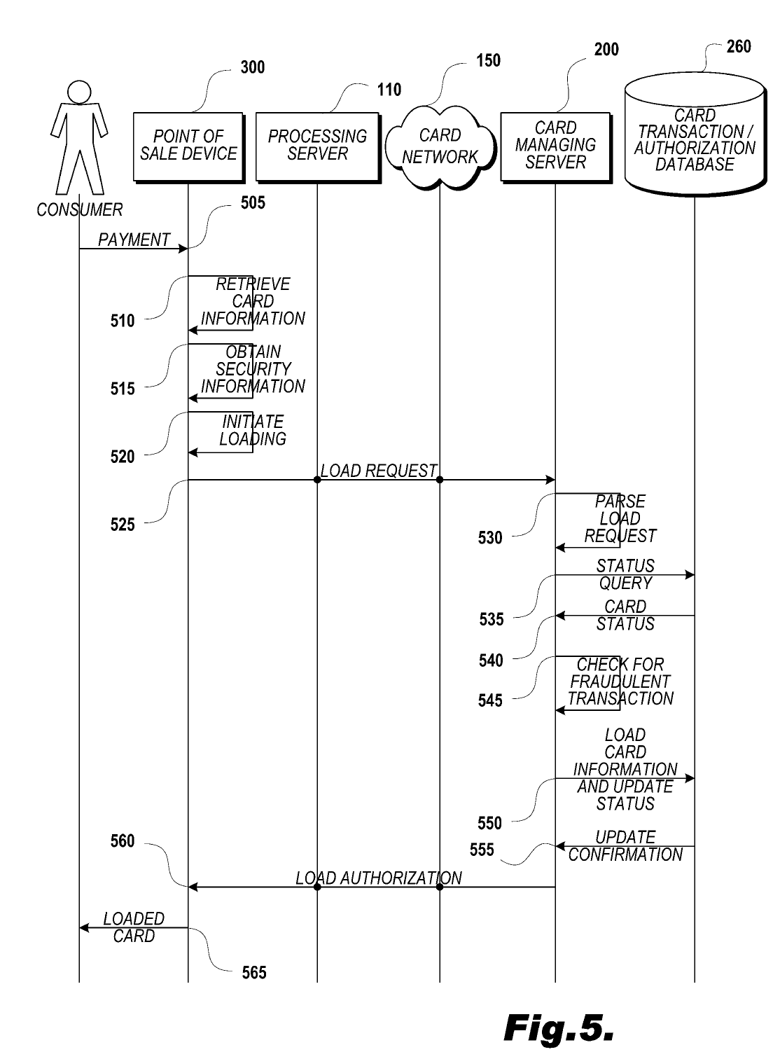

FIG. 5 illustrates steps taken to load a value in real-time onto the loadable debit card 400 in accordance with the present invention. A consumer provides payment 505 to a merchant with a POS device 300. The merchant using the POS device 300 will then retrieve a card and retrieve card information 510 (e.g., an account number) from the card 400. Next, merchant security information is obtained 515, either by the merchant, automatically by the POS device 300 or a combination of both. In one exemplary embodiment the merchant enters a merchant PIN and the POS device 300 has a POS identification number that are both used as security information. After the security information is obtained 515, the merchant initiates a loading transaction 520 (real time debit return with a pin, debit correction, or debit reversal with transaction code) at their POS device 300. Loading transactions of the present invention are those transactions that normally take place when a refund is being issued to an existing debit card. However, in prior art systems, these transactions were unavailable for loading gift cards or private debit cards, such as card 400. Prior art systems would reject such transactions at the card network level. In accordance with the present invention, the merchant with the POS device 300 has activated the POS device 300 in such a way with the card network 150 as to allow loading transactions to be initiated for loading values onto debit cards in accordance with the present invention. In one exemplary embodiment, the activation of the POS device 300 includes obtaining approval from a card network provider to allow such transactions. The load request (of a designated amount) from the POS device 300 is then communicated to a processing server 110, which forwards it, via the card network 150, to the card managing server 200. Once the card managing server 200 receives the load request 525, it is parsed 530 to determine the card information, the POS and processors' information, and the amount of the transaction. A status query 535 is sent to the card transaction/authorization database 260 to determine the current status of the card and its associated account and the current status is then returned 540 to the card managing server 200. Next, the transaction is checked for any fraudulent activity 545 or errors in the transaction. The security information gathered at the POS device 300 is checked, along with the account number of the card 400, to ascertain that the transaction is a legitimate loading transaction. Those of ordinary skill in the art and others will appreciate that a variety of security verification checks may be implemented with such information. Assuming no fraud or errors are present in the transaction, the card information is loaded 550 to a card transaction/authorization database 260. Once the card information has been loaded and updated at the card transaction/authorization database 260, the card managing server 200 receives an update confirmation 555 from the card transaction/authorization database 260. The card managing server 200 then sends a load authorization 560 back, via the card network 150 and the processing server 110, to the POS device 300. Once the merchant receives the authorization at their POS device 300, they then provide 565 the card 400 to the consumer as a loaded card.

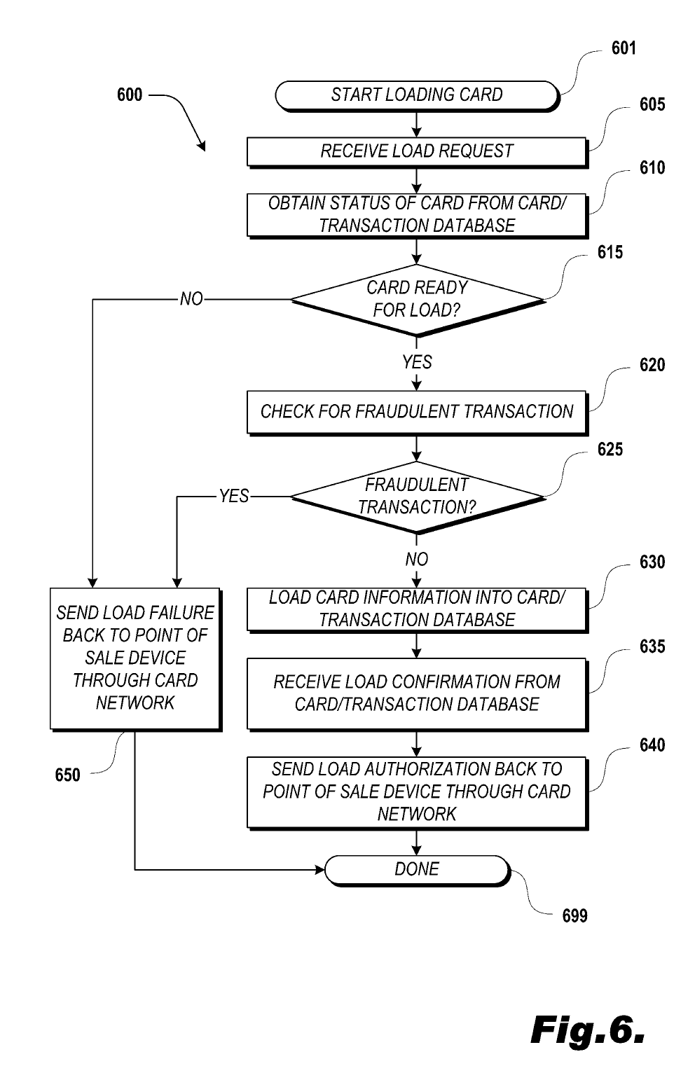

FIG. 6 illustrates an exemplary card loading routine from the view of the card managing server 200. The card loading routine beings in block 601 and proceeds to block 605 where it receives a load request. Next, in block 610, the status of the card is obtained from the card transaction/authorization database 260. Next, in decision block 615, a determination is made whether the status of the card with the card transaction/authorization database 260 indicates that the card is ready for loading. If it was found in decision block 615 that the card was not ready for loading, a load error is sent back to the POS device 300 through the card network 150 in block 650 and processing ends at block 699. Otherwise, if in decision block 615 a determination is made that the card is ready for loading, then, in block 620, the card managing server 200 checks for fraudulent transactions or errors in the transaction. Security information included in the load request (e.g., merchant PIN and POS device 300 identification) is checked, along with the account number of the card 400, to ascertain that the transaction is a legitimate loading transaction. Those of ordinary skill in the art and others will appreciate that a variety of security verification checks may be implemented with such information. Next, in decision block 625, a determination is made whether any errors or fraudulent aspects are found in the transaction and, if they were found, then processing continues to block 650. Otherwise, if no errors or fraudulent indications were found for the transaction, then, in block 630, the card information, along with the information in the load request (e.g., load amount, processor information, and point of sale information), is loaded into the card transaction/authorization database 260. In block 635, the card managing server 200 receives a confirmation that the card information has been loaded and updated in the card transaction/authorization database. Once the load has been confirmed, then, in block 640, the card managing server sends the load authorization back to the POS device 300, via the card network 150 and the processing server 100. Routine 600 then ends at block 699.

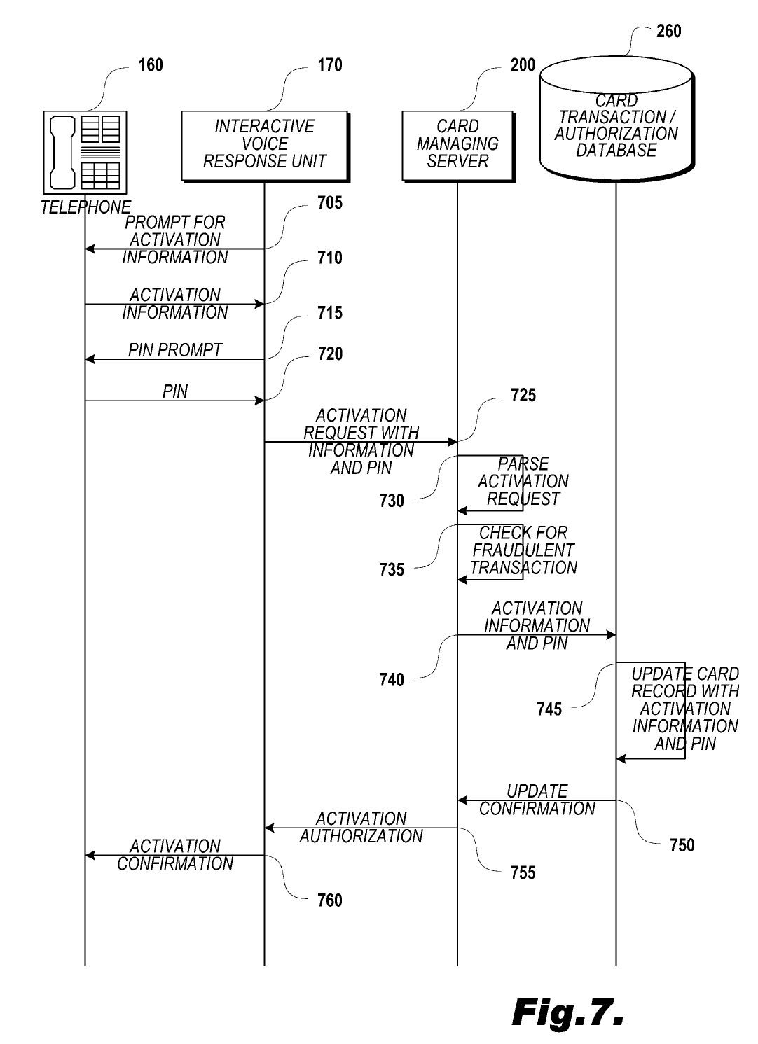

To better illustrate the operation of activating the loaded debit card of the present invention, FIG. 7 illustrates one exemplary embodiment of the actions performed by a system for activating the loadable debit card. The system of FIG. 7 includes a telephone 160 and interactive voice response unit 170, a card managing server 200 and a card transaction/authorization database 260. Upon connection with the interactive voice response unit 170, the telephone 160 receives a prompt 705 for activation information. The customer enters activation information 710 (e.g., account number, security code and possibly other optional registration information, such as a customer name and contact information) into the telephone 160 via voice, rotary, touch tone or other technology known to those of ordinary skill in the art. Upon receipt of the activation information the interactive voice response unit 170 requests 715 a personal identification number (“PIN”). The customer may then enter a PIN 720 via voice, rotary, touch tone or other means using the telephone 160. Once the IVRU 170 has received the PIN it forwards an activation request 725 with the activation information and PIN to the card managing server 200. The card managing server parses 730 the activation requests to extract the relevant card information and PIN number and checks for any fraudulent transactions 735 or errors in the activation request (e.g., by determining if an initial transaction was performed to load value onto the card 400). Assuming that no fraud or errors are found then the activation information and PIN is forwarded 740 to the card transaction/authorization database 260 where the appropriate card record is updated 745 with the activation information and PIN and marked as activated. The update is confirmed 750 back to the card managing server 200 which then sends the activation authorization 755 to the interactive voice response unit 170. The interactive voice response unit 170 may then send activation confirmation 760 to the customer, via the telephone 160, either contemporaneously with the activation requests or at a later point. It will be appreciated by those of ordinary skill in the art that other activation methods may also be employed such as via messaging systems and/or data communications over a network. Such alternate systems would operate in a similar manner, but substitute alternate communication devices instead of a telephone 160 and IVRU 170.

It will be appreciated, that in alternate embodiments, other forms of activation may be employed. For example, a user may call a customer service center and activate their loadable debit card with a customer service agent. Still other conventional activation techniques may used as well, such as activating via a Web page or the like.

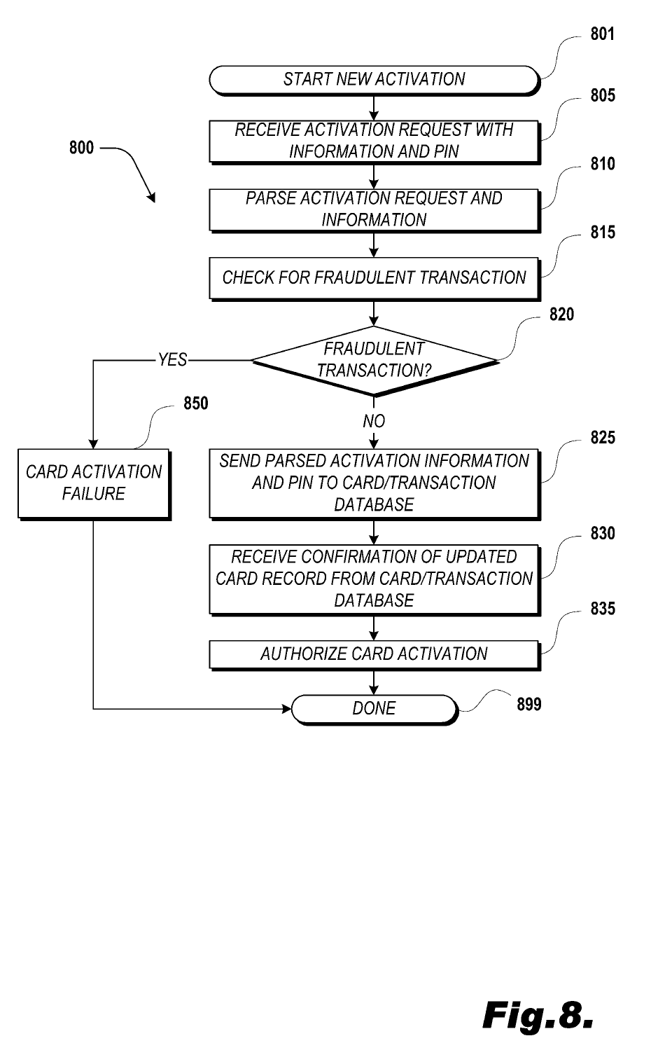

A flow chart illustrating an exemplary activation routine 800 implemented by the card managing server 200 is shown in FIG. 8. The activation routine 800 begins at block 801 and proceeds to block 805 where an activation request is received with activation information and a PIN. Next, in block 810, the activation request is parsed to retrieve relevant information including the activation information and the PIN. The activation information may include any form of information that would be appropriate for activating the loadable debit card, such as the numbers embossed on the front of the card with an additional set of numbers (e.g., a security code) that may be provided separately or printed in alternate placement on the card such as on the reverse side of the card. Additionally, the PIN information will be selectable by the consumer or, in one alternate embodiment, may be assigned at the time of loading by a merchant and provided to the consumer as a further means of authentication during activation. The flow of routine 800 continues to block 81 5 where the activation transaction is checked for any fraudulent or flawed components. If no flaws, errors or fraudulent indicators were found in decision block 820, processing continues to block 825. Otherwise, if a flaw, error or fraudulent indicator was found then, in block 850, a card activation failure is sent out by the card managing server 200 and routine 800 ends at block 899. Back in block 825 the card managing server 200 sends the parsed activation information and PIN to the card transaction/authorization database 260. Next, in block 830, the card transaction/authorization database 260 sends back a confirmation of the updated card record which is received by the card managing server 200. Routine 800 then continues to block 835 where the card activation is authorized and routine 800 then ends at block 899.

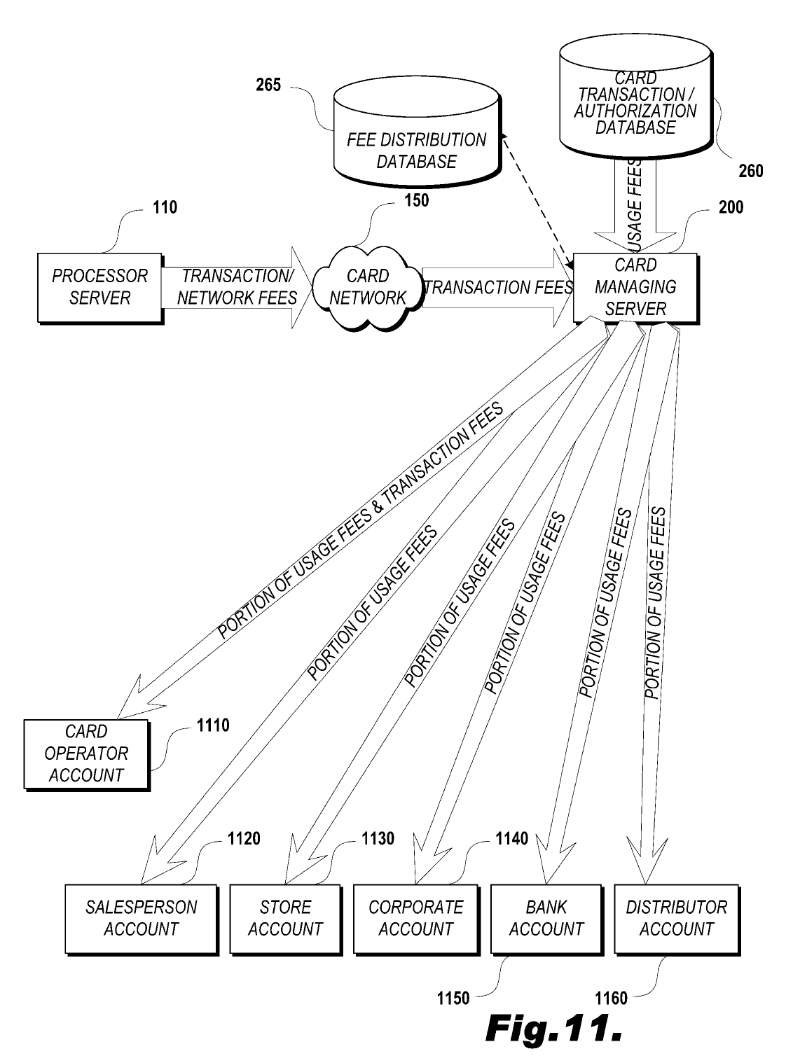

In the past, debit cards only had transaction fees associated with the use of the card and their associated account may have had banking fees that were unrelated to the use of the card (i.e., the banking fees would have been charged regardless of whether the card had a balance, was present, used, or not used). These previous transaction fees typically only benefited either a merchant or a bank or, in the case of an ATM machine, the ATM's bank or the ATM's operator. Accordingly, debit cards were typically only used in the past by banking institutions that could collect these collateral transaction fees. Some merchants did issue their own debit “gift” cards, however, these usually were limited to use within a particular merchant's store or stores. As all the transaction fees and/or costs associated with the card went to the merchant, there was no incentive for other merchants or banks to recognize these cards. However, the card system of the present invention does not merely limit the incentives to transaction fees associated with the card, rather, there is a card account fee that is charged to the cardholder so long as they carry a balance on the card. In one exemplary embodiment this is a $0.25 per day charge, such that on any given day that there is a balance on the card up to $0.25 is deducted per day from that card account. If the balance is less than $0.25 on any given day, then the card account has the total balance deducted and thereafter has no account fees taken from the card account until there is a balance again on the card account. Using such a $0.25 per day fee equates to approximately $7.50 a month, not dissimilar from conventional banking charges for standard accounts. However, unlike conventional bank accounts, the fees collected from the card are distributed to a number of different entities in accordance with the present invention. FIG. 11 illustrates one exemplary breakdown of the fee distribution system, however, those of ordinary skill in the art will appreciate that any number of fee distribution systems may be utilized, either with more or fewer entities receiving fees as appropriate under market conditions.

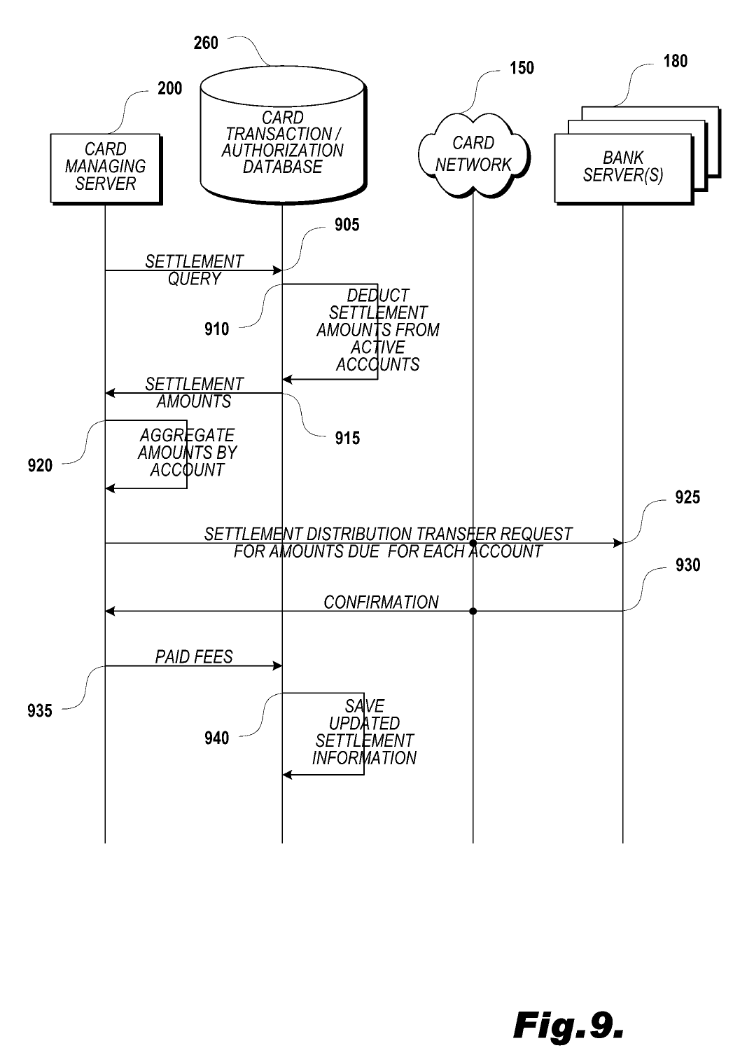

In addition to loading and activating the loadable debt card 400, the present invention allows for the settling of transactions and the distribution of fees associated with the use of the loadable debit card 400. To better illustrate the settlement operations, FIG. 9 illustrates one exemplary embodiment of actions performed by a system for settling transactions. The system of FIG. 9 includes the card managing server 200, the card transaction/authorization database 260, the card network 150 and bank server or servers 180. The settlements are periodically performed and are initiated when the card managing server 200 sends a settlement query 905 to the card transaction database 260 to determine which transactions and fees are ready for settlement. This may occur at regular time intervals or, in one embodiment, when sufficient transactions have reached a level where the settlement transaction will be of a predetermined size (e.g., if at least $100,000 in fees will be distributed). In another embodiment settlement queries 905 may happen more often, but only accounts receiving over a predetermined amount are used for queries. For example, if the account only is due $0.10, it is not reported until the amount due reaches some threshold, such as $10. The settlement amounts are deducted from active accounts identified at the card transaction/authorization database 260. The card transaction database 260 returns 915 a listing of the settlement amounts which are ready of settlement. The card managing server 200 then aggregates 920 settlement amounts for the payment transactions received from the card transaction database 260 and the fees for balances on cards, and aggregates the payments and fees by account, as provided in the fee distribution database 265 (not shown in FIG. 9). The aggregated payments and fees are then forwarded 925, via the card network 150, to a bank server 180 for transfer to the appropriate accounts. It will be appreciated by one of ordinary skill in the art and others that these payments may be sent to a bank server 180 if the bank server 180 is managing the accounts. If there is a plurality of different institutions managing the accounts for which payments and fees are to be sent then, in another embodiment, the central account server 120 may receive the settlement transfer requests and forward them to different banking servers, as determined from its account database 125. However, in one exemplary embodiment illustrated in FIG. 9, a single bank server 180 is used. Once the settlement transfer requests have been received and processed by the bank server 180 a confirmation 930 is returned, via the card network 150, to the card managing server 200. The card managing server 200 then sends 935 the list of completed settlement transactions back to the card transaction/authorization database 260, where the updated settlement information is saved 940.

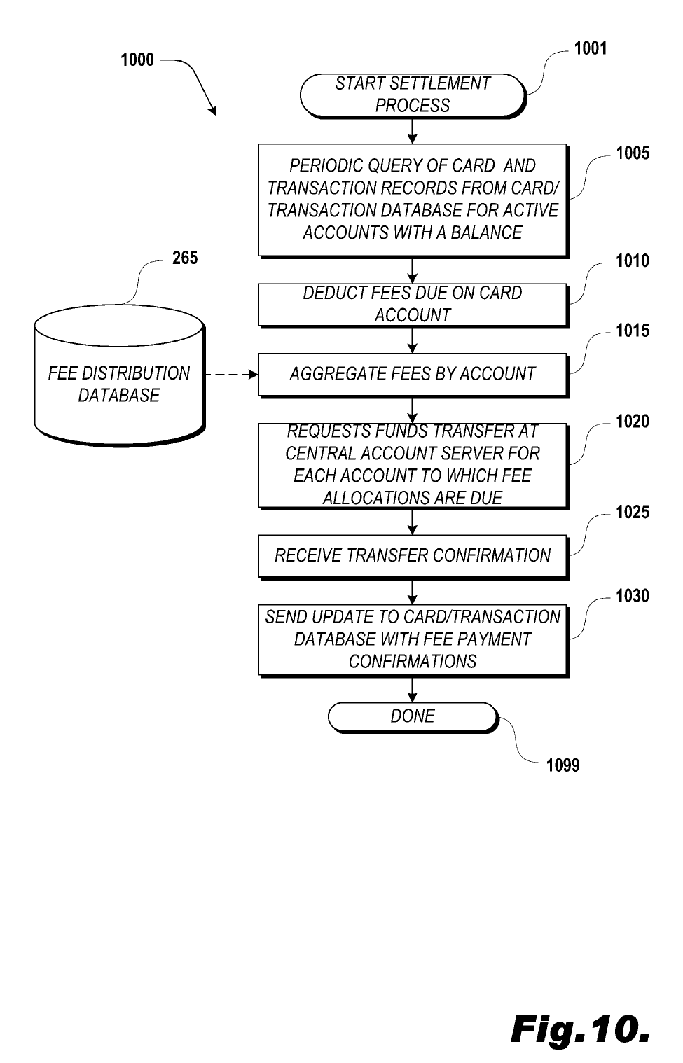

Much as illustrated in FIG. 9, FIG. 10 illustrates the settlement process from the point of view of the card managing server 200. Settlement routine 1000 starts at block 1001 and proceeds to block 1005 where the transaction records for the periodic settlement are retrieved from the card transaction/authorization database 260. Next, in block 1010, the fees due on payment transactions and payments due to particular accounts are determined. Then, in block 1015, the payments and fees are aggregated by account (assisted by the fee distribution database 265) to minimize the number of transactions requested from the server in charge of accounts. In block 1020, the funds transfer request is sent for all the accounts for which funds are due, including payments and fees. Block 1020 may send the funds transfer request either to a bank server 180 or the funds transfer requests may be send to a central account server which will manage the transfers to a plurality of banking servers. The funds transfer requests are confirmed upon completion which is received in block 1025. Next, in block 1030, the card managing server 200 sends an update to the card transaction/authorization database 260 indicating that all the completed transactions were received from the confirmation in block 1025. Routine 1000 then ends at block 1099.

FIG. 11 illustrates one exemplary fee distribution system illustrating the collecting and distribution of fees in accordance with the present invention. For purposes of simplicity, only two types of fees are illustrated in FIG. 11, usage fees and transaction fees. The transaction fees are those fees that are associated with debit card transactions in a conventional debit card network, such as merchant fees, card network fees, and/or banking fees. For example, if a consumer were to pay for $10 of gasoline at a gas station with a surcharge for using debit cards, there would be a $0.25 surcharge which goes to the gas station, e.g., the merchant, which is collected at their process server 110. Next, there would be a card network fee which is usually a fixed amount plus a percent of a transaction, in this case perhaps $0.10 plus 2% of the transaction, which is another $0.30 and that $0.30 is distributed between the card network and the banking institution or institutions involved according to conventional mechanisms in the debit card system. So, accordingly, in FIG. 11 we see a process server 110 sending transaction and network fees to a card network 150. The card network “absorbs” the network fees and passes on any remaining transaction fees to the card institution in this invention, represented by the card managing server 200. The card managing server sends those transaction fees to a card operator account 1110. However, in addition to the conventional transaction fees associated with a debit card, there are the usage fees which, in one embodiment of the invention, is $0.25 per day that a card carries a balance. Accordingly, once a day a query is run on the card transaction database 260 and the usage fees are calculated and sent to the card managing server 200, which then distributes a portion of the usage fees to various accountholders. In one exemplary embodiment shown in FIG. 11 a portion of the usage fees goes to the card operator account 1110, a salesperson account 1120, a store account 1130, a corporate account 1140, a bank's account 1150, and a distributor account 1160. Of course, more or fewer accounts may be used in alternate embodiments. Those of ordinary skill in the art will appreciate that although the singular is used when describing accounts, the plural applies as well in that there may be a multitude a salesperson accounts 1120, store accounts 1130, corporate accounts 1140, banks' accounts 1150, and distributor accounts 1160. However, it is generally anticipated that there will be a smaller number of card operator accounts 1110, possibly even only a single card operator account 1110.

In one exemplary embodiment the $0.25 fee is distributed proportionately as follows: The salesperson/people get $0.03 to the salesperson account 1120, the merchant gets $0.05 to the store account 1130, the corporation owning the store gets $0.03 to the corporate account 1140, the bank gets $0.01 to the bank's account 1150 and the distributor gets $0.01 for the distributor account 1160. The remaining $0.12 goes to the card operator account 1110. Other distributions and parties may be used in other embodiments. For example, if the company owning the merchant's store has over one million cards they may get a higher share (perhaps $0.05).

While the distribution of the usage fees is shown as going to a particular account, the card managing server utilizes the fee distribution database 265 to determine exactly which accounts will receive which portion of the usage fees. After which, the share going to that account is transferred using conventional banking systems, such as the automated clearinghouse (“ACH”) transfer system, to transfer the fees to the appropriate account. Such conventional banking systems usually have a cost associated with such a transfer, which is deducted from the amount transferred to the account on a per transfer basis in one embodiment of the present invention.

In another exemplary embodiment of the present invention, certain accounts may elect to receive their transfers on a less frequent basis. Accordingly, the card managing server may view the accountholders' records in the fee distribution database and only initiate a transfer once conditions have been met. In an exemplary embodiment, the condition may be that transfers occur monthly. In another exemplary embodiment, the transfers may only be initiated once a certain threshold of fees, such as $10, $20 or $100, have been aggregated as payable to the accountholder. Those of ordinary skill in the art will appreciate that many combinations and variations of the fee distribution system described above may be made without departing from the spirit and scope of this invention.

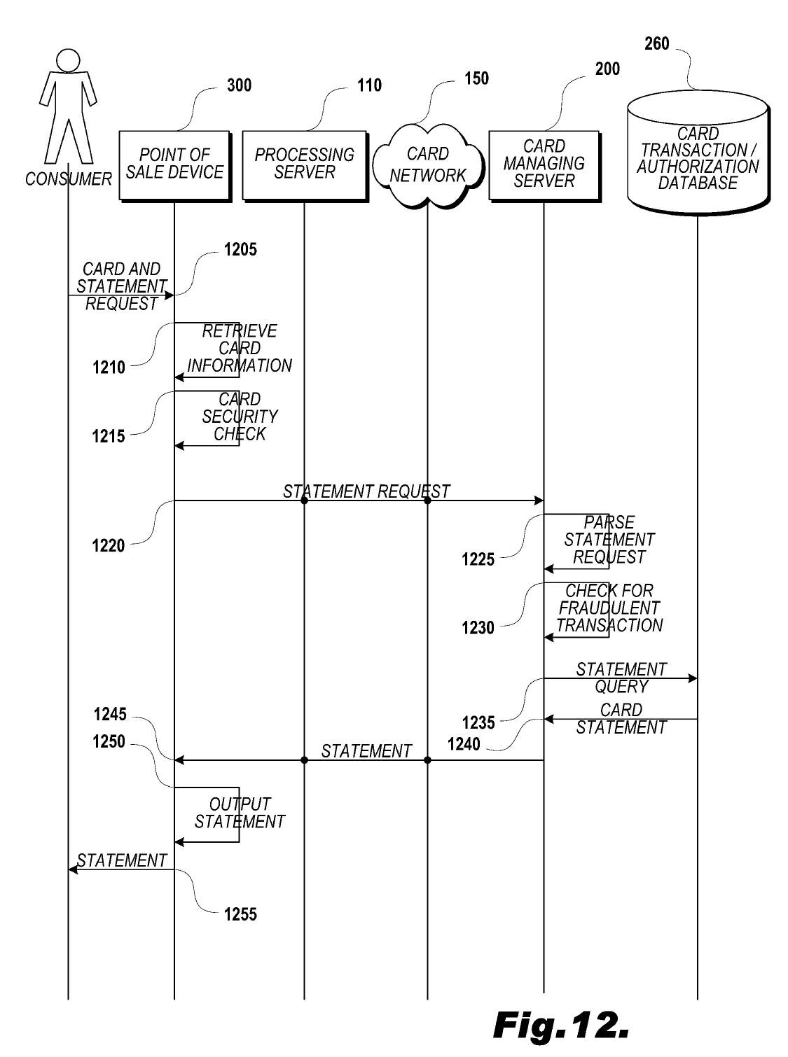

In addition to providing benefits to merchants and operators, the present invention provides additional benefits to consumers. For example, the present invention allows consumers to retrieve account statements in an efficient and anonymous manner. FIG. 12 illustrates steps taken to retrieve a statement for the loadable debit card 400. A consumer requests a statement 1205 from a POS device 300 (or an ATM). The POS device retrieves 1210 card information from the card 400. Next, a card security check 1215 is performed by the POS device 300. Once it is determined that the card 400 is a valid card and has passed the security check, the POS device initiates a statement request 1220 that is communicated to a processing server 110, which forwards it, via the card network 150, to the card managing server 200. Once the card managing server 200 receives the statement request, it is parsed 1225 to determine the card information. Next, the transaction is checked for any fraudulent activity 1230 or errors in the transaction. Assuming no fraud or errors are present in the transaction, the statement query 1235 is sent to card transaction/authorization database 260. The card transaction/authorization database 260 then sends the card statement 1240 to the card managing server 200. The card managing server 200 then sends the statement 1245 back, via the card network 150 and the processing server 110, to the POS device 300. Once the POS device 300 outputs 1250 the statement (either at a display or, optionally, at a printer 195), the consumer may then retrieve 1255 their statement. In an alternate embodiment the POS device 300 is supplanted by an Automated Teller Machine (“ATM”) that prints the statement and outputs the statement from an internal printer (not shown).

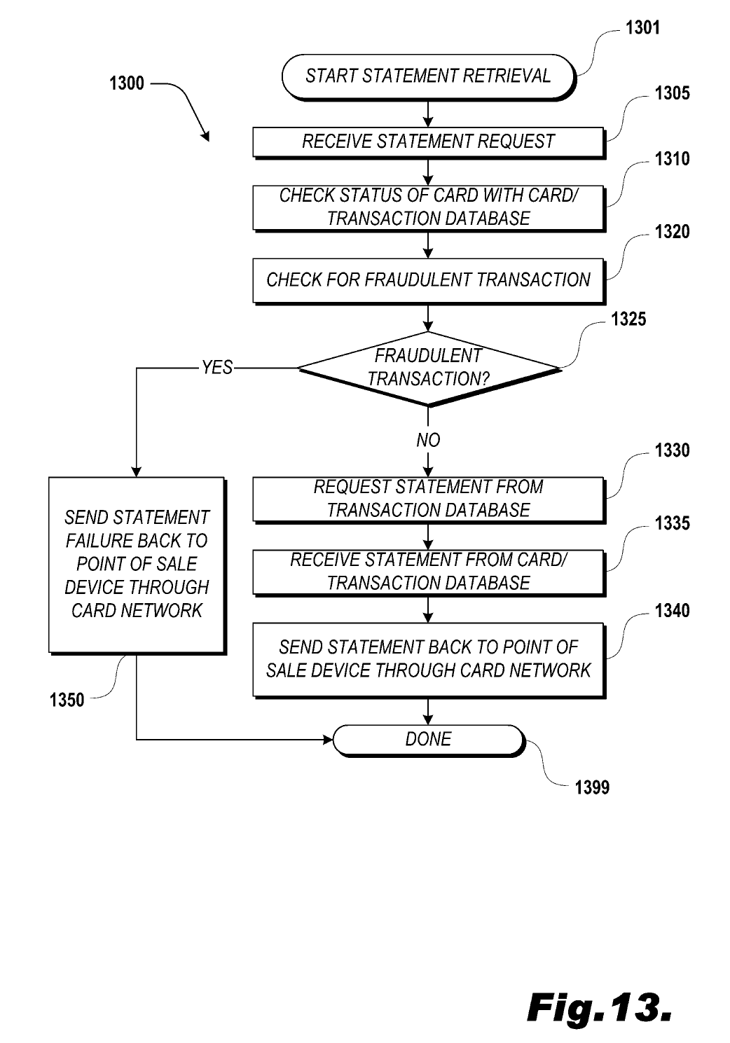

FIG. 13 illustrates an exemplary statement retrieval routine from the view of the card managing server 200. The statement retrieval routine beings in block 1301 and proceeds to block 1305 where it receives a statement request. Next, in block 1310, the status of the card is checked with the card transaction/authorization database 260, to determine whether the status of the card with the card transaction/authorization database 260 indicates that the card is ready for loading. Then, in block 1320, the card managing server 200 checks for fraudulent transactions or errors in the transaction. Next, in decision block 1325, a determination is made whether any errors or fraudulent aspects were found in the transaction and, if they were found, then processing continues to block 1350 where an error is sent back to the POS device through the card network and processing ends at block 1399. Otherwise, if no errors or fraudulent indications were found for the transaction, then, in block 1330, a statement request is sent to the card transaction/authorization database 260. Then, in block 1335, the card managing server 200 receives the card statement from the card transaction/authorization database 260. In block 1340, the card managing server sends the statement back to the POS device 300, via the card network 150 and the processing server 110. Routine 1300 then ends at block 1399.

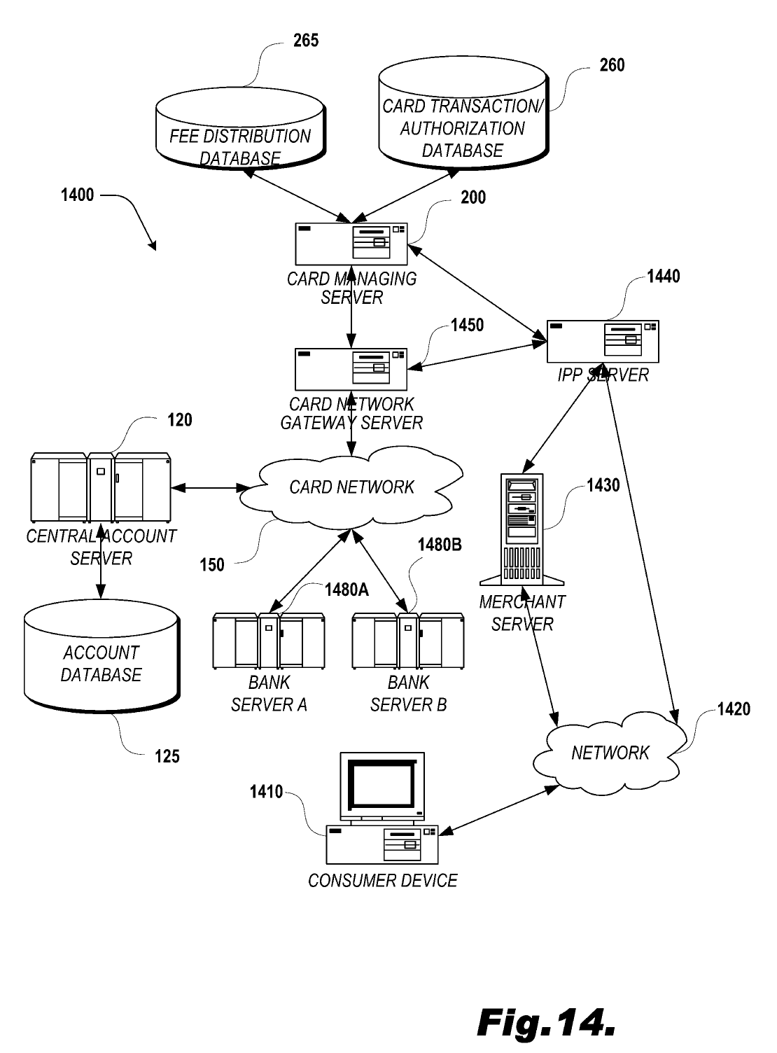

FIG. 14 illustrates an exemplary embodiment of a number of devices used in embodiments of the present invention. FIG. 14 illustrates a consumer device 1410 connected via a network 1420 to a merchant server 1430 and an Internet Processing Platform (“IPP”) server 1440. The network 1420 may be any form of network that is capable of passing communications between a consumer device 1410 and the merchant server 1430 and/or IPP server 1440. The merchant server 1430 handles merchant transactions with the consumer device 1410, e.g., purchasing of goods and/or services. The IPP server serves as an interface to the online payment processing in accordance with embodiments of the present invention. The IPP server 1440 is communicatively linked with a card network gateway server 1450 that serves as an interface to the card network 150. Also communicatively linked to the IPP server is the card managing server 200 illustrated in FIG. 2 and described above. The card managing server 200 includes a card transaction/authorization database 260 and a fee distribution database 265. The card managing server 200 interfaces with the card network gateway server 1450 to communicate with other devices connected to the card network 150. Such other devices include a central account server 120 that includes an account database 125 and bank servers 1480A and 1480B. It will be appreciated by one of ordinary skill in the art and others that more or fewer devices may be present in a system 1400 in an actual embodiment of the present invention. The system 1400 shown on FIG. 14 is meant to illustrate one simplified embodiment of the present invention and is not meant to limit the actual implementations that embodiments of the present invention may form.

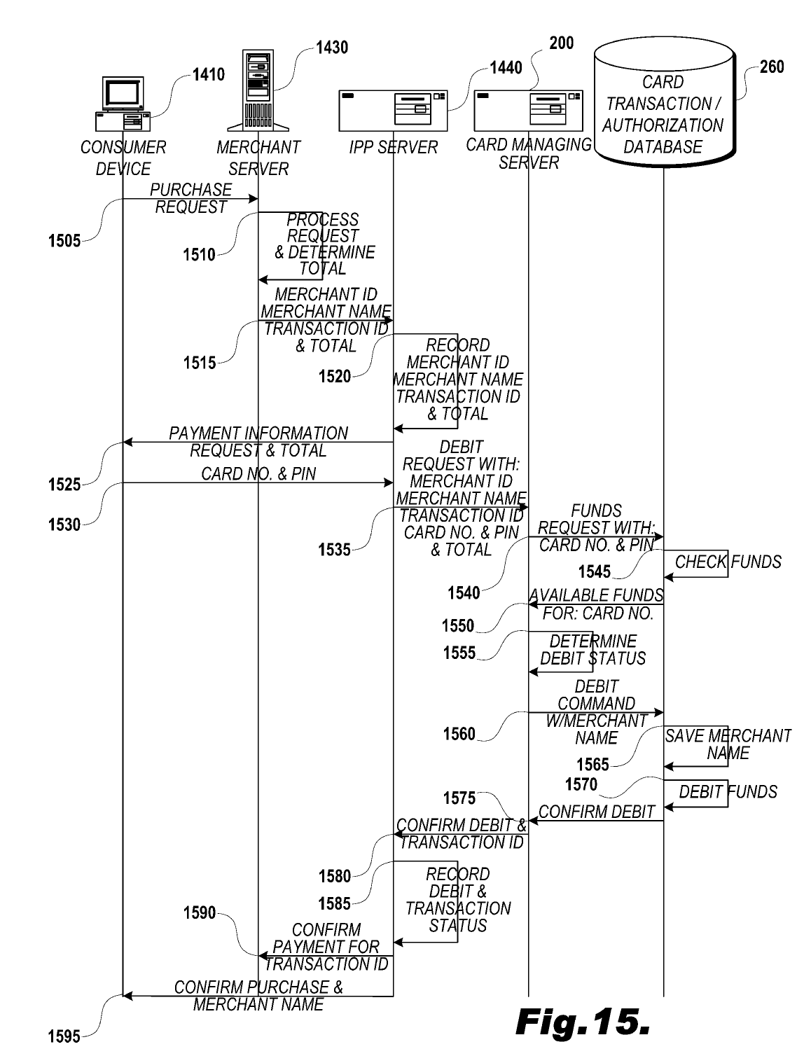

FIG. 15 illustrates communications and interactions between a consumer device 1410, merchant server 1430, IPP server 1440, card managing server 200 and a card transaction database 260 to process an online payment transaction for goods and/or services provided by a merchant associated with the merchant server 1430. The payment transaction interactions shown in FIG. 15 begin with a purchase request 1505 from the consumer device 1410 to the merchant server 1430. Once the purchase request 1505 has been received the merchant server 1430 processes the request and determines a total cost 1510 for the transaction. The merchant server 1430 then sends 1515 a merchant identifier, a merchant name, a transaction identifier and a total amount for the transaction to the IPP server 1440. The IPP server 1440 records 1520 the merchant identifier, merchant name, transaction identifier and the total amount for further processing. Next, the IPP server 1440 sends 1525 a payment information request and the transaction total amount back to consumer device 1410, thereby prompting the consumer device 1410 to request payment information from a user of the consumer device 1410. Next, the consumer device 1410 returns a loadable debit card number and PIN 1530 (or other authentication information, such as biometric identification information, cryptographic handshake information, username and password information, challenge/response information or the like) to the IPP server 1440. Those of ordinary skill in the art and others will appreciate that many forms of card identifiers and authenticating information may be used in accordance with various embodiments of the present invention. In the exemplary embodiment illustrated in FIG. 15 a card number and personal identification number (or other authentication information) are used as card identifying information and authorizing information, respectively. In other embodiments of the present invention a non-numeric card identifier may be used and the authorizing information may be more complex than a PIN number. For example, a challenge response system with a dynamically generated password may be used in further embodiments of the present invention. In yet other embodiments, a biometric indication may be used as authorizing information for the payment transaction of embodiments of the present invention.

Once the IPP server 1440 receives the payment information it sends a debit request 1535 with a merchant identifier, merchant name, transaction identifier, card number, PIN and a total amount of the transaction to a card managing server 200. The card managing server 200 then queries the card transaction database 260 with a funds request 1540 with the card number and PIN. The card transaction database 260 checks 1545 for available funds in an account associated with the card number and the PIN and returns 1550 the available funds associated with that account to the card managing server 200. The card managing server 200 determines whether there are sufficient funds to perform a debit of the transaction total amount from the account associated with the card number and PIN. Assuming that such a determination was positive, processing proceeds at the card managing server with a debit command 1560 sent along with the merchant name to the card transaction database 260. The card transaction authentication database 260 saves the merchant name 1565 and debits the transaction total 1570 from the account associated with the card number and PIN and returns a confirmation 1575 to the card managing server 200. The card managing server 200 confirms the debit and sends the transaction identifier 1580 back to the IPP server 1440. The IPP server 1440 records the debit 1585 and transaction status and confirms the online payment transaction 1590 along with the transaction identifier to the merchant server 1430. Additionally, the IPP server 1440 may also confirm the purchase and merchant name 1595 to the consumer device 1410.

Those of ordinary skill in the art and others will appreciate that the online payment transaction communications and interactions shown in FIG. 15 are merely illustrative of one exemplary embodiment of the present invention for processing online payment transactions and that other embodiments of the present invention may have different communications and interactions between similar and dissimilar computing devices.

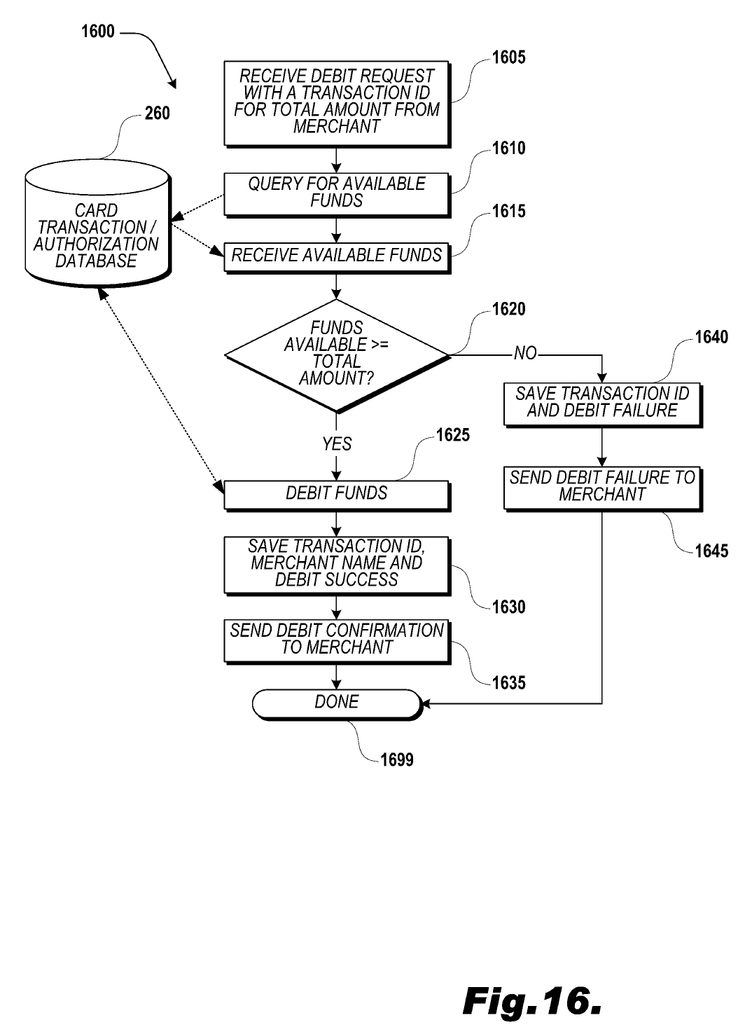

FIG. 16 illustrates an exemplary online payment transaction routine 1600 for purchasing goods and/or services from a merchant. Online payment processing routine 1600 begins at block 1605 where a debit request is received with a transaction identifier for a total amount from a merchant. In block 1610 a card transaction database 260 is queried for available funds and, in block 1615, the amount of available funds is received from the card transaction database 260. Next, in decision block 1620, a determination is made whether the available funds is at least equal to (i.e., equal to or greater than) the total amount received from the merchant. If so, processing proceeds to block 1625 where the funds are debited (or marked to be debited) from the card transaction database 260. In block 1630 the transaction identifier, a merchant name and the record of a successful debit transaction are saved. In block 1635 the debit transaction's completion is confirmed back to the merchant and processing ends at block 1699. If, however, in block 1620 it was determined that the funds are not at least equal to the total amount, processing proceeds to block 1640. In block 1640 the transaction identifier is saved along with an indication of a debit failure. An indication of the debit failure is sent back to the merchant in block 1645 and processing ends at block 1699. Those of ordinary skill in the art and others will appreciate that the online payment transaction routine 1600 is presented from the view of the card managing server 200. However, in further embodiments of the present invention, the card managing server 200 and the IPP server 1440 may be combined in a single device and, accordingly, further actions may be present in such an online payment transaction. Additionally, it will be appreciated that alternate embodiments of the present invention may include more, fewer or different actions than those illustrated in online payment transaction routine 1600. For example, in one additional embodiment, the query for available funds and the determination of whether the available funds are sufficient for the transaction may be combined in a single query to the database that includes the transaction total amount. Additional alternate embodiments will be apparent to those of ordinary skill in the art and others.

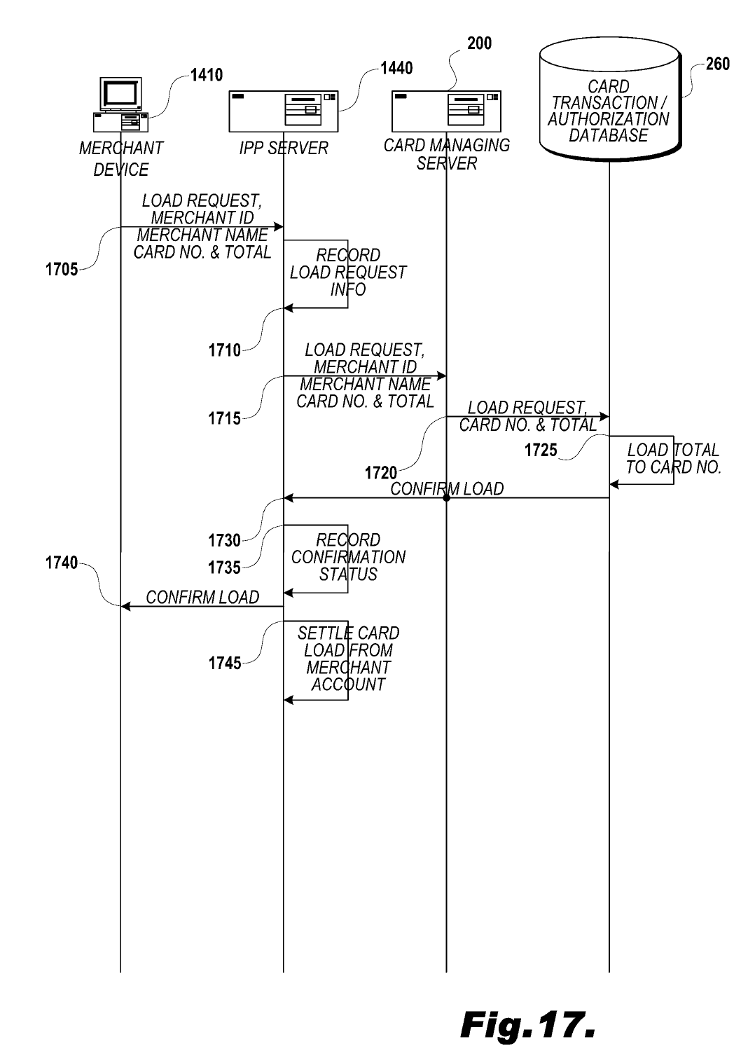

In addition to processing online payment transactions, embodiments of the present invention include a settlement mechanism for merchants whereby funds that have been settled to a “pool” account may be loaded onto loadable debit cards for use by the merchant and/or their designees. FIG. 17 illustrates the actions and communications between a merchant device 1410, IPP server 1440, card managing server 200 and a card transaction/authorization database 260 to provide funds to loadable debit cards of a merchant. The interactions begin with the merchant device 1410 submitting 1705 a load request, including a merchant identifier, merchant name, card number and a total load amount to the IPP server 1440. The IPP server 1440 records the load request information 1710 and submits 1715 the load request including the merchant identifier, merchant name, card name and total to the card managing server 200. The card managing server 200 submits a load request 1720 with the card number and total to the card transaction/authorization database 260. The card transaction/authorization database 260 loads 1725 the total amount to an account associated with the card number and returns a confirmation 1730, via the card managing server 200, to the IPP server 1440. The IPP server 1440 records 1735 the confirmation and confirms 1740 the load to the designated card to the merchant device 1410. The IPP server 1440 also settles 1745 the card load from the merchant's pool account.

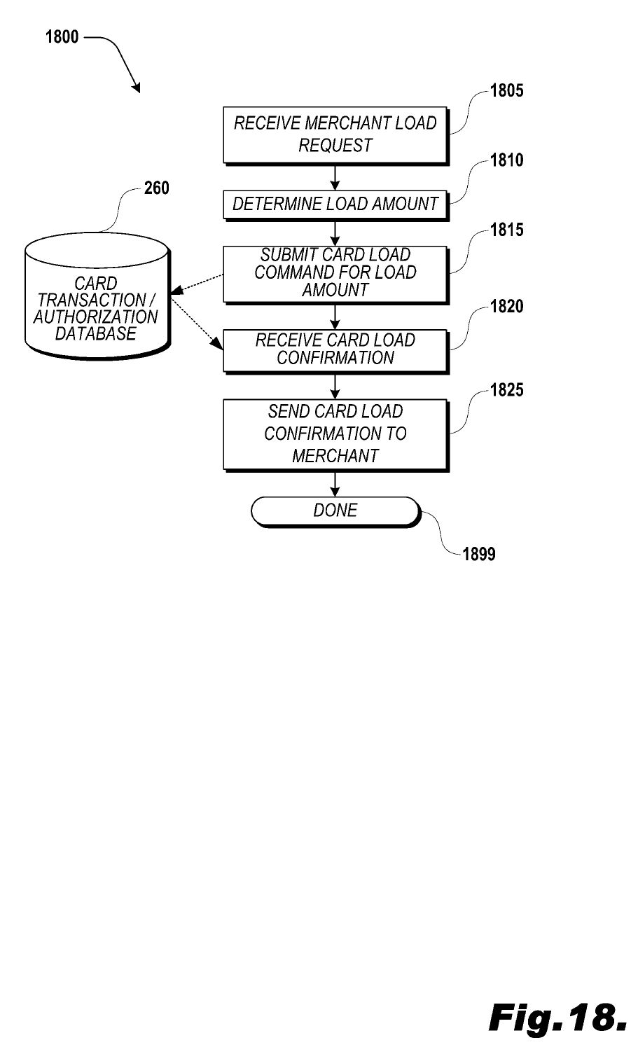

FIG. 18 illustrates an exemplary merchant load request routine 1800 for loading money from a merchant's pool account into a loadable debit card associated with the merchant and/or pool account. Merchant load request routine 1800 begins at block 1805 where a merchant's load request is received. In block 1810 the amount of the load request is determined. Next, in block 1815, a card load command is submitted for the determined load amount to the card transaction database 260. The card transaction database 260 confirms the loading of the card which is received in block 1820. Next, in block 1825 a card load confirmation is sent to the merchant and routine 1800 ends in block 1899.

Those of ordinary skill in the art and others will appreciate that additional actions may be used in further embodiments of the present invention when loading from a merchant pool account to a loadable debit card associated with a merchant and/or the pool account. For example, an additional query may be used to determine if a loadable debit card is actually associated with a particular merchant and/or pool account. Additionally, in further embodiments of the present invention, conventional authentication and security verifications are performed to maintain the security of the merchant's pool account. It will be appreciated by those of ordinary skill in the art and others that the card transaction/authorization database 260 may store additional information about a merchant's pool account and/or loadable debit cards. For example, the card transaction/authorization database 260 may have total load limits, daily load limits, load confirmation requirements and other restrictions on one or more loadable debit cards that may be associated with a merchant's pooled account. In other exemplary embodiments the merchant pool itself may have imposed limits that prevent certain load transactions by date, time, amount and the like.

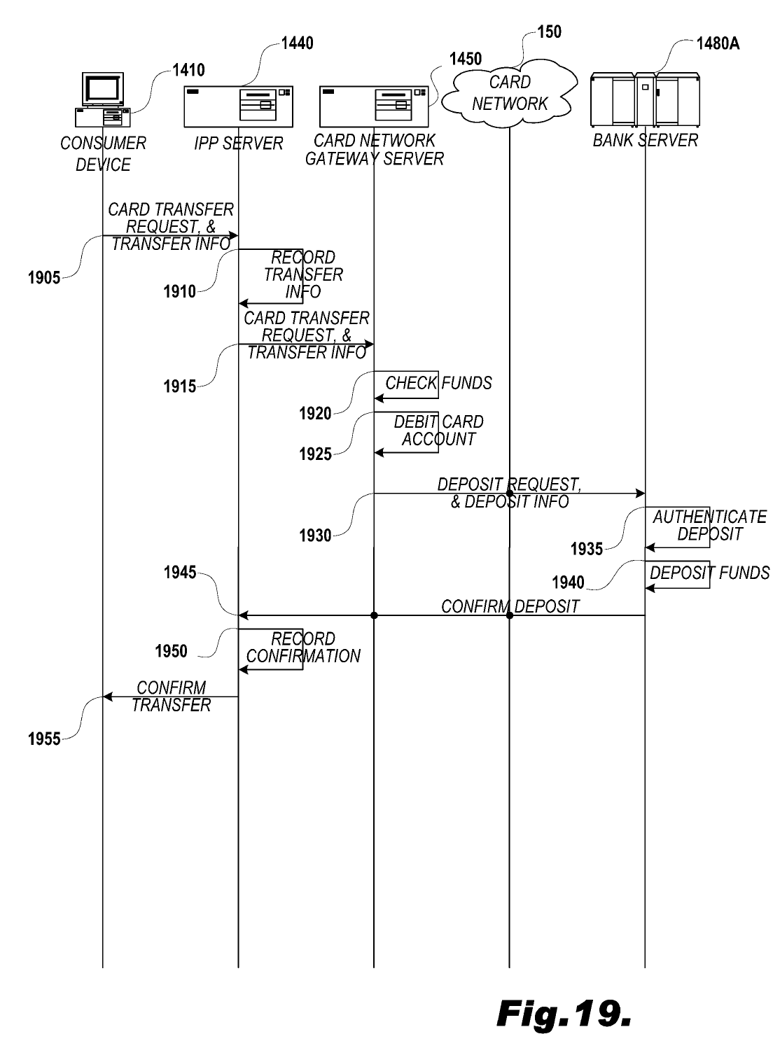

In addition to paying for goods and/or services with loadable debit cards and loading funds from a merchant into specified loadable debit cards, it is also possible to transfer funds from a loadable debit card to a conventional bank account (or to another loadable debit card account). FIG. 19 illustrates the actions and communications between a number of devices to transfer funds from a loadable debit card account to a bank account (or loadable debit card account) using a conventional debit card network 150. In FIG. 19 a consumer device 1410 initiates 1905 a card transfer request that includes transfer information to an IPP server 1440. The transfer information includes a card identifier, authentication information (such as a PIN, biometric information or the like) and a transfer amount. Those of ordinary skill in the art and others will appreciate that in other embodiments of the present invention a bidirectional communication between the consumer device 1410 and the IPP server 1440 may be used to iteratively gather this information, however in the illustrated embodiment in FIG. 19 such information is packaged in a single transfer request. Next, the IPP server 1440 records the transfer information 1910 (possibly without the authenticating information). The IPP server 1440 sends a card transfer request 1915 with the transfer information to the card network gateway server 1450. The card network gateway server checks for available funds 1920 in the account associated with the loadable debit card in the transfer information. Those of ordinary skill in the art and others will appreciate that, in one embodiment, such a transfer would be communicated to the card transaction/authorization database 260 for verification. In alternate embodiments of the present invention, fund availability information is available at the card network gateway server 1450. The card network gateway server 1450 next debits 1925 the card account associated with the loadable debit card identified in the transfer information for the request transfer amount. Next, the card network gateway server 1450 sends a deposit request 1930 with deposit information including the necessary deposit information to make a deposit for the amount deducted from the loadable debit card account via the card network 150 to a bank server 1480A. The bank server 1480A authenticates 1935 the deposit and deposits 1940 the funds into a specified account associated with the bank server 1480A. The bank server 1480 A confirms 1945 the deposit via the card network 150 and the card network gateway server 1450, to the IPP server 1440. The IPP server 1440 records the confirmation 1950 and confirms 1955 the transfer of funds back to the consumer device 1410. Those of ordinary skill in the art and others will appreciate that the actions and communications illustrated in FIG. 19 are merely illustrative examples of one exemplary embodiment of the present invention and that other actions and communications may be used to effectuate a transfer from a loadable debit card to a specified conventional bank account without departing from the spirit and scope of the present invention.

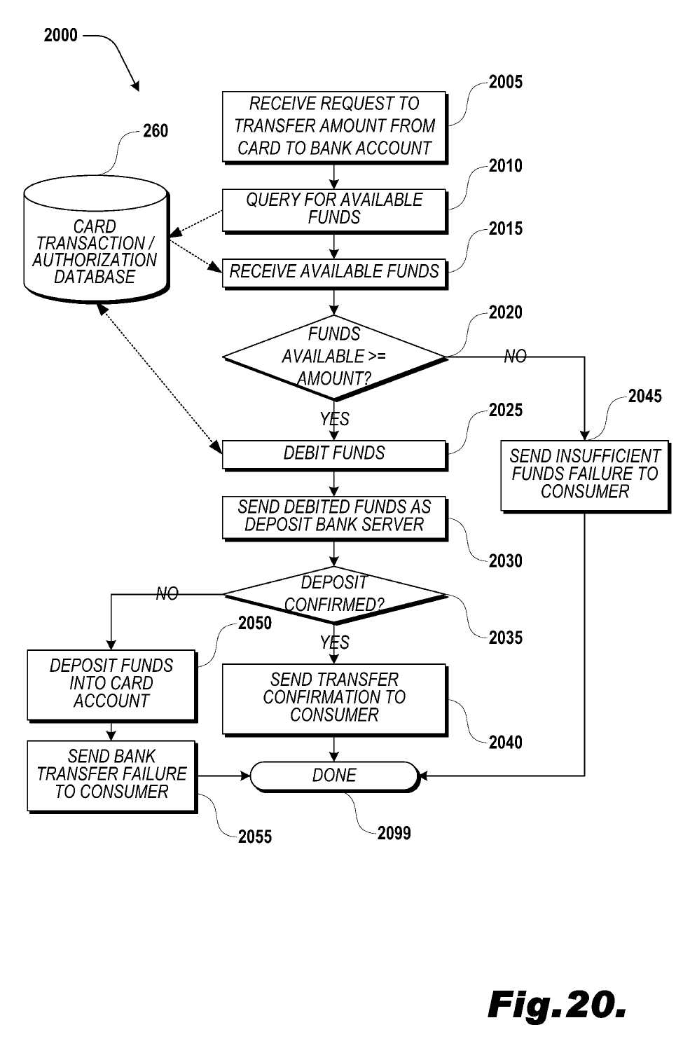

To better illustrate the operation of transferring funds from a loadable debit card to a conventional bank account FIG. 20 illustrates one exemplary card to bank account transfer routine 2000. Transfer routine 2000 begins at block 2005 where a transfer request is received to transfer an amount to a bank account. In block 2010 the card transaction database 260 is queried for available funds in the loadable debit card's account. The card transaction/authorization database 260 then returns the available funds in block 2015. In decision block 2020 a determination is made whether the funds are at least equal to the requested transfer amount. If so, in block 2025 the transfer amount is debited from the loadable debit card account at the card transaction/authorization database 260. In block 2030 the debited funds are sent as a deposit to a remote bank server with a designation of a particular bank account into which the funds should be deposited. In decision block 2035 a determination is made whether the deposit was confirmed from the bank server. If so, processing continues to block 2040 where a transfer confirmation is sent back to the consumer and transfer routine 2000 ends at block 2099. Returning to decision block 2020, if there are insufficient funds in the loadable debit card account, then in block 2045 an insufficient funds failure is sent to the consumer to let them know that the transfer was not successful and processing ends at block 2099. Similarly, if in decision block 2035 it was determined that there was not deposit confirmation, then in block 2050 the funds are redeposited into the loadable debit card account from which they were taken. Next, in block 2055 a bank transfer failure is sent to the consumer to indicate that the transfer was not successful and processing ends at block 2099.

Those of ordinary skill in the art and others will appreciate that the card transfer functions illustrated in FIGS. 19 and 20 allow for the transfer between a loadable debit card account and any other debit card account accessible from a consumer device 1410 (e.g., a personal computer, phone, automated teller machine, computer kiosk and the like).

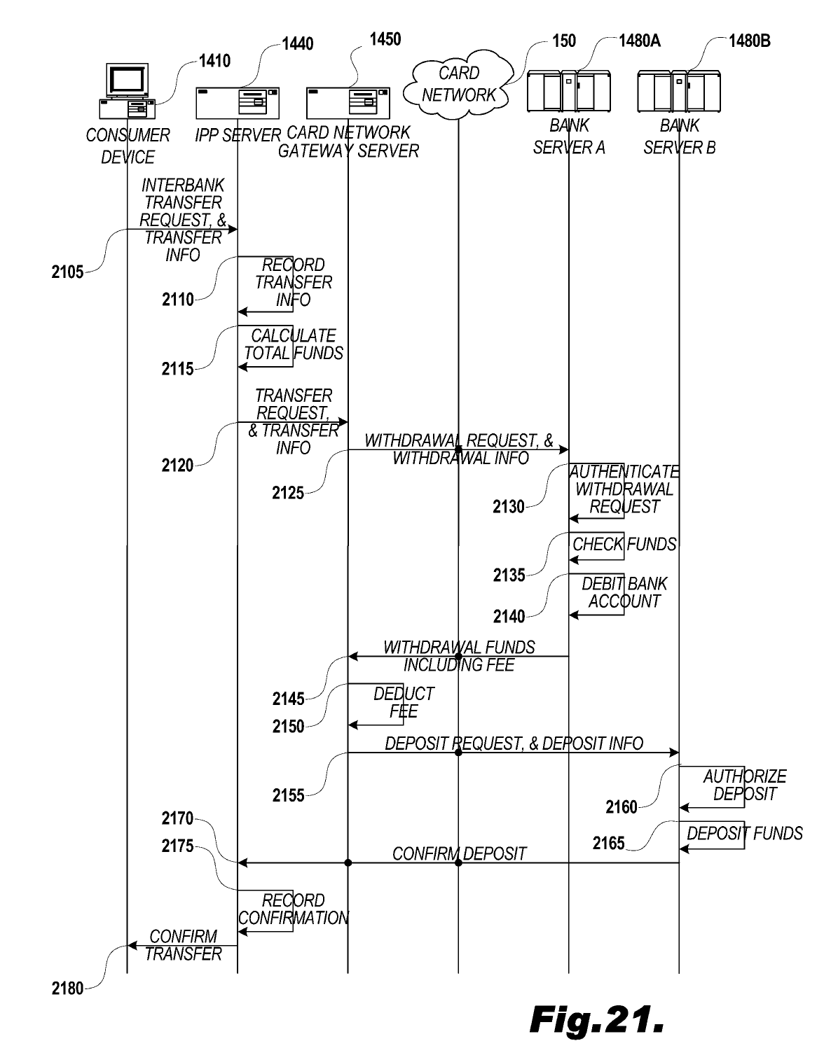

Similarly to the card to bank account transfer illustrated in FIGS. 19 and 20, further embodiments of the present invention allow the transfer of funds from one bank account to another bank account on a separate banking server (i.e., an inter-bank transfer) using a conventional debit card network 150. FIG. 21 illustrates the communications and actions between the consumer device 1410, IPP server 1440, card network gateway server 1450, card network 150, a first bank server A 1480A and a second bank server B 1480B. First, the consumer device 1410 initiates an inter-bank transfer request 2105 with transfer information (originating account, authorizing information for the originating account, a transfer amount, a destination account and authorization for the destination account) to the IPP server 1440. The IPP server records 2110 transfer information and calculates 2115 total funds needed for a transfer. The calculation of total funds needed for a transfer may include the addition of additional fees from a first bank A, a second bank B and the provider of the transfer service. Such additional fees may or may not also include card network fees and the like. The IPP server 1440 then sends the transfer request 2120 with transfer information (updated with the new total funds required and/or an indication of any additional fees to the card network gateway server 1450. The card network gateway server 1450 sends a withdrawal request 2125 including withdrawal information via the card network 150 to the first bank server A 1480A. The withdrawal information includes the necessary information to withdraw funds from bank server A (e.g., a bank account, authorizing information and an amount to withdraw). The bank server A 1480A authenticates 2130 the withdrawal request, checks for funds 2135 and debits 2140 a bank account with the requested amount (including any necessary fees calculated for the total transaction). The bank server A 1480A then sends the withdrawal funds 2145 back to the card network gateway server 1450. Card network gateway server 1450 then deducts 2150 any fees received. Next, the card network gateway server 1450 sends a deposit request 2155, including sufficient deposit information (e.g., an account, authorizing information and the necessary information to authorize the deposit of the remaining withdrawal funds), via the card network 150, to bank server B 1480B. Bank server B 1480B authorizes 2160 the deposit and deposits 2165 into the specified account. Bank server B 1480B then confirms the deposit 2170 via the card network 150, card network gateway server 1450 to the IPP server 1440. The IPP server 1440 records 2175 the confirmation and, in turn, confirms the inter-bank transfer 2180 to the consumer device 1410.

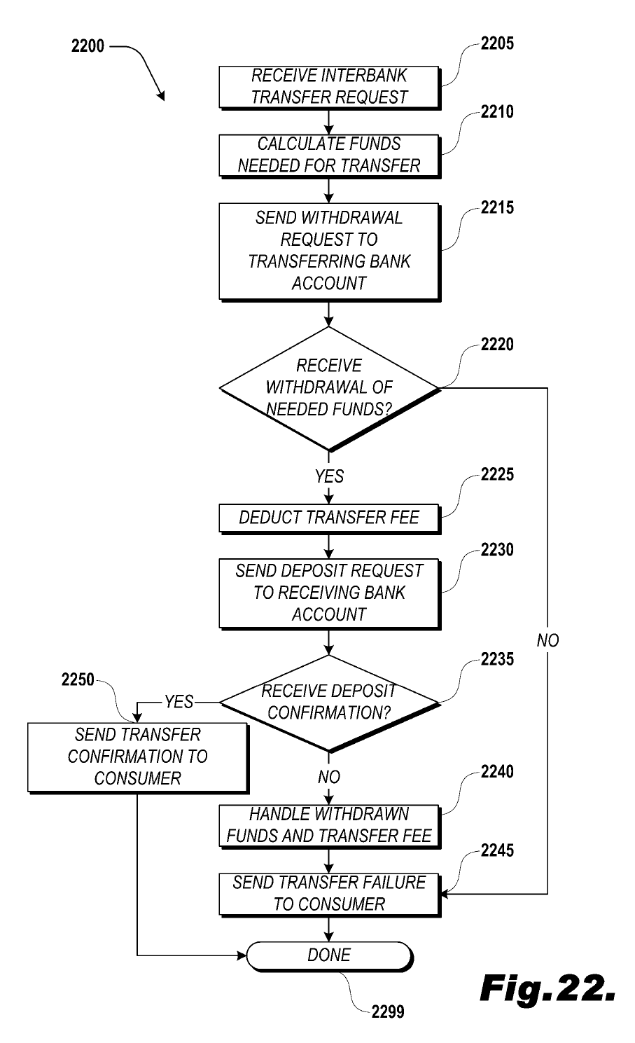

To better illustrate the inter-bank transfer of the present operation of the present invention FIG. 22 illustrates an inter-bank request routine 2200. Those of ordinary skill in the art and others will appreciate that the inter-bank request routine 2200 is performed substantially at the IPP server 1440 and/or the card network gateway server 1450. Inter-bank transfer routine 2200 begins at block 2205 where an inter-bank transfer request is received. In block 2210 the funds needed to complete the transfer are calculated, including any calculations of fees. Next, in block 2215 a withdrawal request is sent to the transferring bank account for the total funds needed to complete the transfer (i.e., the amount to be transferred plus any additional fee or fees). In decision block 2220 a determination is made whether the needed funds were withdrawn and received. If so, processing continues to block 2225 where the transfer fee (or fees) is deducted from the withdrawn amount. In block 2230 a deposit request is sent to a receiving bank account. In block 2235 a determination is made whether a deposit confirmation has been received back from the receiving bank account. If so, in block 2250, transfer confirmations are sent back to the consumer, originating bank and the transferring bank, inter-bank transfer 2200 ends at block 2299. If, however, in decision block 2235 it was determined that a deposit confirmation was not received then, in block 2240, the withdrawn funds and transfer fees are handled in an appropriate manner. In one exemplary embodiment of the present invention the transfer fee may be forfeited and the withdrawn funds are redeposited into the transferring bank account. In another embodiment of the present invention both the transfer fee and the other withdrawn funds are redeposited into the transferring bank account. Processing then proceeds to block 2245. Similarly, if in decision block 2220 it was determined that no withdrawal of the needed funds was received, processing also continues to block 2245 where a transfer failure is sent to the consumer. Inter-bank transfer routine 2200 then ends at block 2299.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein. Therefore, it is manifestly intended that this invention be limited only by the claims and the equivalents thereof.

1. A computer implemented method of processing an online payment transaction of a loadable debit card, the method comprising:
receiving from a merchant a debit request including a merchant identifier, a transaction identifier associated with the online payment transaction, and a total amount;
prompting a user in communication with said merchant in a secure manner for a loadable debit card identifier and authorization information;
determining that a balance of an account associated with said loadable debit card identifier is at least equal to said total amount;
deducting said total amount from said balance; and
confirming the online payment transaction associated with said transaction identifier to said merchant.

2. The method of claim 1, further comprising associating said debit request with said loadable debit cart identifier and said authorization code.

3. The method of claim 1, wherein determining comprises querying a database for a balance of an account associated with said loadable debit card identifier.

4. The method of claim 1, wherein said debit request further comprises a merchant name.

5. The method of claim 4, further comprising confirming the online payment transaction to a user device.

6. The method of claim 4, further comprising determining that said merchant identifier and said merchant name are properly associated.

7. The method of claim 4, further comprising associating said merchant name with said transaction identifier and generating a statement including a transaction entry with at least said merchant name, a transaction date and said total amount.

8. The method of claim 1, further comprising looking up a merchant name associated with said merchant identifier.

9. The method of claim 8, further comprising associating said merchant name with said transaction identifier and generating a statement including a transaction entry with at least said merchant name, a transaction date and said total amount.

10. The method of claim 1, wherein prompting a user comprises generating a prompt window in a user interface where said window is selected from the group consisting of a new Web page, a pop-up Web page, a dialogue window, a new browser window, a refreshed Web page, a new client application window and a new XML generated window.

11. The method of claim 1, wherein prompting a user includes retrieving a state preserving token from a computing device of a user.

12. The method of claim 1, wherein determining that a balance of an account associated with said loadable debit card identifier is at least equal to said total amount comprises providing said total amount and said loadable debit card identifier to a remote computer and receiving an indication that said balance is at least equal to said total amount.

13. The method of claim 1, wherein said total amount is deducted from said balance in real time.

14. The method of claim 1, wherein said total amount is marked against said balance but is deducted after a delay in time.

15. The method of claim 1, wherein a portion of said total amount is settled with said merchant in real time.

16. The method of claim 1, wherein a portion of said total amount is settled with said merchant after a delay in time.

17. The method of claim 16, wherein a portion of said total amount is aggregated with other portions of transaction amounts for settlement.

18. A computing device having a processor and a memory with computer executable instructions which, when executed by said processor, perform the method of claim 1.

19. A computer readable medium having executable instructions, which when executed perform the method of claim 1.

20. A loadable debit card adapted for online payment transactions, the loadable debit card, comprising:
a loadable debit card identifier;
authorization information associated with said loadable debit card identifier; and
having an account associated with said loadable debit card identifier with a stored value comparable to values of one or more online transaction total values, said account also capable of responding to an online deduction request for a specified amount.

21. A computer implemented method of processing an online load transaction of a loadable debit card, the method comprising:
receiving from a networked device a load request, including a merchant identifier and a load amount;
prompting a user in a secure manner for loadable debit card identifier and for authorization information;
determining that a balance of a pool account associated with a card account associated with said loadable debit card identifier is at least equal to said load amount; and loading said load amount from said pool account to said card account.

22. The method of claim 21, wherein said load request further comprises a transaction identifier.

23. The method of claim 21, wherein prompting a user comprises generating a prompted window in a user interface where said window is selected from the group consisting of a new Web page, a pop-up Web page, a dialogue window, a new browser window, a refreshed Web page, a new client application window and a new XML generated window.

24. The method of claim 21, wherein prompting a user includes retrieving a state preserving token from a computing device of a user.

25. The method of claim 21, wherein determining that a balance of an account associated with said loadable debit card identifier is at least equal to said load amount comprises providing said load amount and said loadable debit card identifier to a remote computer and receiving an indication that said balance is at least equal to said load amount.

26. The method of claim 21, wherein said load amount is deducted from said balance in real time.

27. The method of claim 21, further comprising confirming the online load transaction to a user device.

28. A computing device having a processor and a memory with computer executable instructions which, when executed by said processor, perform the method of claim 21.

29. A computer readable medium having executable instructions which, when executed, perform the method of claim 21.

30. A computer implemented method of processing an online transfer from a loadable debit card account to a bank account, the method comprising:
receiving from a networked device a transfer request, including a bank account identifier and a transfer amount;
prompting a user of said networked device for a loadable debit card identifier and authorization information associated with the loadable debit card account;
determining that a balance of the loadable debit card account is a least equal to said transfer amount; and
transferring said transfer amount from the loadable debit card account to the bank account.

31. The method of claim 30, wherein said transfer request further comprises a transaction identifier.

32. The method of claim 30, wherein prompting a user comprises generating a prompt window in a user interface where said window is selected from the group consisting of a new Web page, a pop-up Web page, a dialogue window, a new browser window, a refreshed Web page, a new client application window and a new XML generated window.

33. The method of claim 30, wherein prompting a user includes retrieving a state preserving token from a computing device of a user.

34. The method of claim 30, wherein determining that a balance of an account associated with said loadable debit card identifier is at least equal to said transfer amount comprises providing said transfer amount and said loadable debit card identifier to a remote computer and receiving an indication that said balance is at least equal to said transfer amount.

35. The method of claim 30, wherein said transfer amount is deducted from said balance in real time.

36. The method of claim 31, further comprising confirming the online transfer transaction to a user device.

37. A computing device having a processor and a memory with computer executable instructions which, when executed by said processor, perform the method of claim 30.

38. A computer readable medium having executable instructions which, when executed, perform the method of claim 30.

39. A computer implemented method of processing an online transfer from a first bank account to a second bank account, the method comprising:
receiving from a networked device a transfer request, including a bank account identifier and a transfer amount;
prompting a user of said networked device for a first bank account identifier and authorization information associated with the first bank account;
determining that a balance of the first bank account is a least equal to said transfer amount; and
transferring said transfer amount from the first bank account to the second bank account.

40. The method of claim 39, wherein said transfer request further comprises a transaction identifier.

41. The method of claim 39, wherein prompting a user comprises generating a prompt window in a user interface where said window is selected from the group consisting of a new Web page, a pop-up Web page, a dialogue window, a new browser window, a refreshed Web page, a new client application window and a new XML generated window.

42. The method of claim 39, wherein prompting a user includes retrieving a state preserving token from a computing device of a user.

43. The method of claim 39, wherein determining that a balance of an account associated with said first bank account is at least equal to said transfer amount comprises providing said transfer amount and said first bank account identifier to a remote computer and receiving an indication that said balance is at least equal to said transfer amount.

44. The method of claim 39, wherein said transfer amount is deducted from said balance in real time.

45. The method of claim 39, further comprising confirming the online transfer transaction to a user device.

46. A computing device having a processor and a memory with computer executable instructions which, when executed by said processor, perform the method of claim 39.

47. A computer readable medium having executable instructions which, when executed, perform the method of claim 39.
